(19) United States
(12) Patent Application Publication
(10) Pub. No.: US 2008/0167892 A1
(43) Pub. Date: Jul. 10, 2008

(54) SYSTEM FOR RIDE SHARING AND METHOD THEREFOR

(76) Inventors: Neil Clark, Mesa, AZ (US); Aaron Clark, Mesa, AZ (US)

Correspondence Address: WEISS & MOY PC, 4204 NORTH BROWN AVENUE, SCOTTSDALE, AZ, 85251, US

(21) Appl. No.: 11/969,703

(22) Filed: Jan. 4, 2008

Related U.S. Application Data
(60) Provisional application No. 60/884,373, filed on Jan. 10, 2007.

(51) Int. Cl. G06Q 10/00

(52) U.S. Cl. 705/1

(57) ABSTRACT

A method in a computer system for a ride sharing program is disclosed. The computer program will determine an amount of ride units that a ride to a predetermined destination is worth. At least two program members will agree to share the ride. Upon completion of the ride the amount of ride units will be transferred from the account of the ride requiring program member to the account of the ride providing program member. A member may purchase ride units or may earn them by offering rides other program members and completing the rides. Members may also rate each other based on their ride experiences with each other and these comments may be visible by other program members.

### CROSS-REFERENCE TO RELATED APPLICATION

This application claims priority to a corresponding provisional application U.S. Ser. No. 60/884,373, filed Jan. 10, 2007 in the name of the applicants of this application.

### FIELD OF THE INVENTION

This invention relates generally to ride sharing, and more specifically, to an improved system and method for ride sharing using ride units and member ratings.

### BACKGROUND OF THE INVENTION

In an effort to reduce air pollution, people participate in ride sharing, also known as carpooling. Ride sharing has also been used as an avenue for social networking. Some companies and organizations have set up organized carpools and some of these organized carpools are even offered online; however, there is no reliable way for a potential rider to really know with whom he/she is going to be sharing the ride.

In addition to starting and destination locations, some on-line ride sharing programs allow potential riders to share information about their gender and their personal interests for networking purposes. But, much like a personal ad, there is no way to verify that the information provided by a potential rider is truthful. For example, a criminal might use the carpool service as a way to find his/her next victim.

### SUMMARY OF THE INVENTION

It is an object of the present invention to provide a reliable way for a person to know with whom he/she will be sharing a ride.

It is another object of the present invention to use a rating system to help a person decide whether or not to share a ride with a particular person or persons.

It is another object of the present invention to use background checks to help provide for a safer ride sharing environment.

It is another object of the present invention to use ride units to encourage members to offer rides to other members instead of just requesting rides from other members.

### BRIEF DISCRIPTION OF THE PREFERRED EMBODIMENTS

In accordance with one embodiment of the present invention, a method in a computer system for a ride sharing program is disclosed. The method comprises the steps of: determining an amount of ride units for a ride; agreeing between at least two program members to share the ride; and transferring the amount of ride units from an account of one program member to an account of a another program member upon completion of the ride.

In accordance with another embodiment of the present invention, a method in a computer system for a ride sharing program is disclosed. The method comprises the steps of: logging on to the computer system by a ride providing program member; posting an offer for a ride to a predetermined destination by the ride providing program member; determining an amount of ride units for the ride to the predetermined destination; storing the offer for the ride in a database; logging on to the computer system by a at least one ride requiring program member; browsing a list of posted ride offers stored in the database by the at least one ride requiring program member; posting an acceptance for the offer for the ride to the predetermined destination by the at least one ride requiring program member; notifying the ride providing program member of the posting of the acceptance for the ride to the predetermined destination; posting by the ride providing program member of one of an agreement response and a rejection response to the acceptance for the offer for the ride that was posted by the at least one ride requiring program member; agreeing between the ride providing program member and the at least one ride requiring program member to share the ride; and transferring the amount of ride units from an account of the at least one ride requiring program member to an account of the ride providing program member upon completion of the ride.

In accordance with another embodiment of the present invention, a computer readable medium containing instructions for controlling a computer system for facilitating a ride sharing program is disclosed. The computer readable medium contains instructions for facilitating a ride sharing program comprising the steps of: determining an amount of ride units for a ride by the computer system; agreeing between at least two program members to share the ride; and transferring the amount of ride units from an account of a ride requiring program member to an account of a ride providing program member upon completion of the ride.

The foregoing and other objects, features, and advantages of the invention will be apparent from the following, more particular, description of the preferred embodiments of the invention, as illustrated in the accompanying drawings.

### BRIEF DESCRIPTION OF THE DRAWINGS

FIG. 1 is a simplified functional block diagram of the system of the present invention.

FIG. 2 is a flowchart depicting the application and registration steps of the method of the present invention.

FIG. 3 is a sample membership application form.

FIG. 4 is a sample member general file form.

FIG. 5 is a sample member security file form.

FIG. 6 is a flowchart depicting the planning and sharing steps of the method of the present invention.

FIG. 7 is a sample ride posting form.

### DETAILED DESCRIPTION OF THE PREFERRED EMBODIMENTS

The present invention, as well as a preferred mode of use and advantages thereof, will best be understood by reference to the following detailed description of illustrated embodiments when read in conjunction with the accompanying drawings.

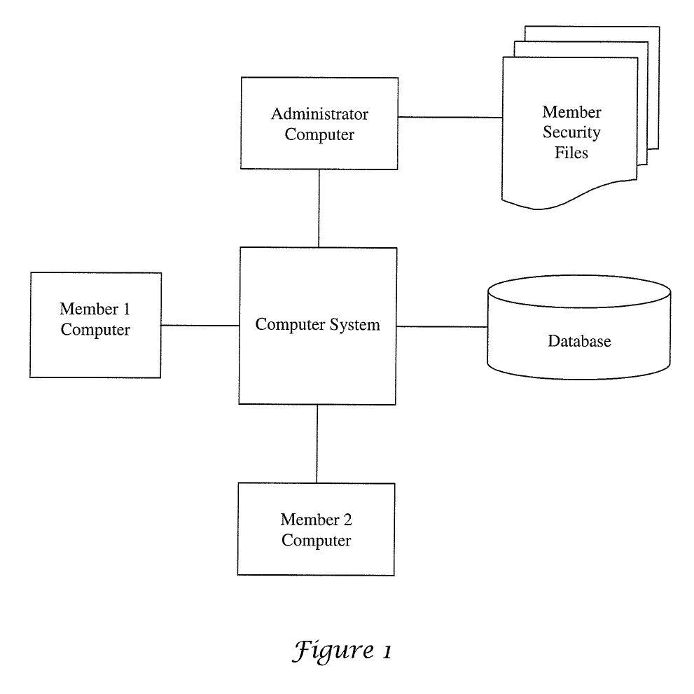

FIGS. 1-7 show a preferred embodiment of the present invention. Together they show an improved system and method for ride sharing using ride units and member ratings.

FIG. 1 shows the organization of the system in accordance with an embodiment of the present invention. Preferably, the system of the current invention will be run on a computer and all membership information will be stored in a database that is accessible by the computer. Further preferably, administrators as well as any members will be able to access the computer system online. While only two members and one administrator are shown as having access to the computer system, it should be clearly understood that any number of members and/or administrators may have access to the system.

As shown in FIG. 1, member security files (discussed below) will only be accessible by an administrator. While it is shown that the member security files are accessible online by an administrator, it should be clearly understood that substantial benefit may be derived from the member security files being kept in paper form at a secure location. Further substantial benefit may also be derived from the member security files being kept on a separate computer that is not accessible online.

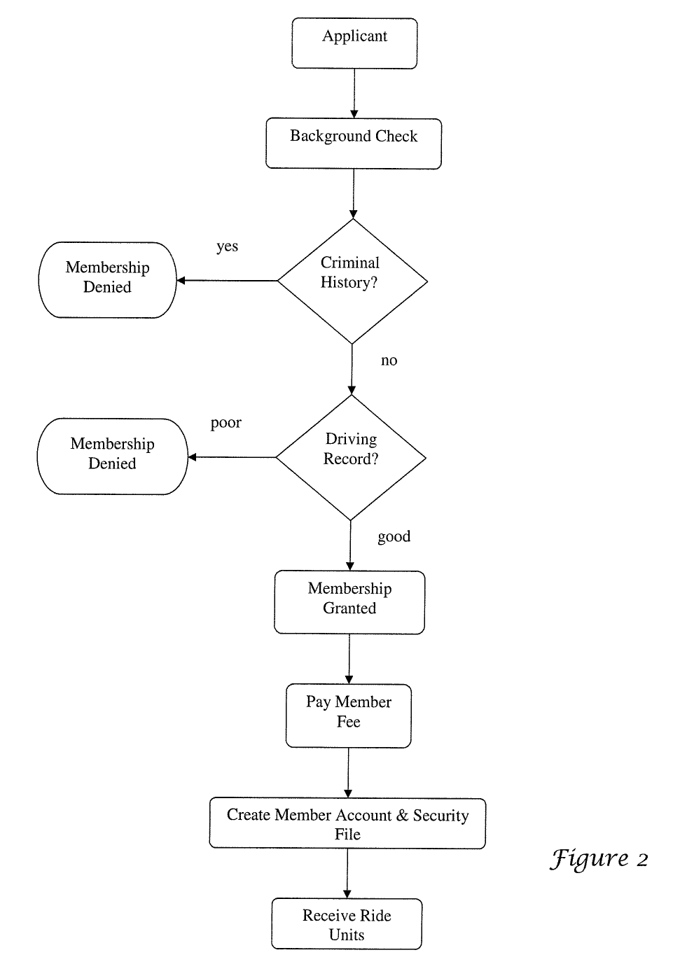

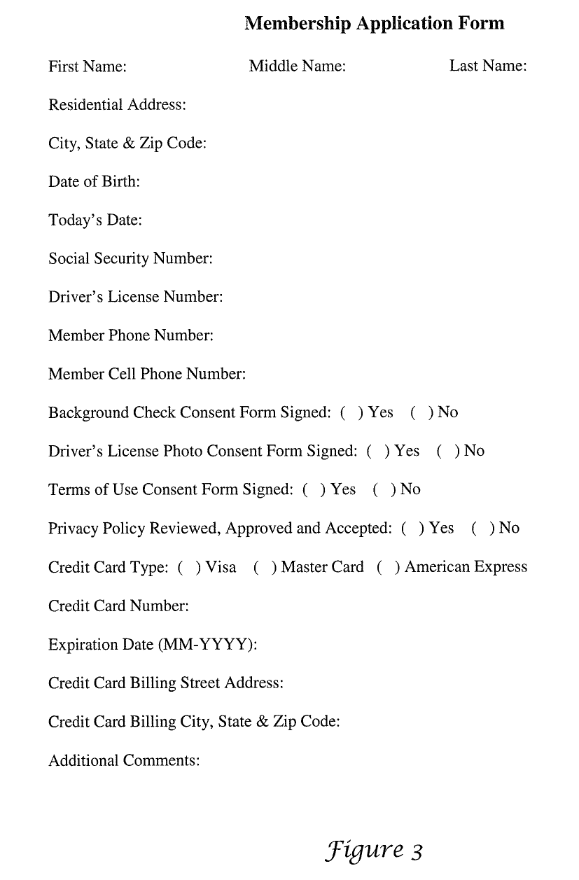

FIG. 2 shows the steps that a person will take to apply for membership and, if granted, register for access to the system. FIG. 3 shows a sample membership application form, that an applicant will fill out and submit, preferably online. On the membership application form, the applicant will provide personal information that includes, but is not limited to, the applicant's first and last name, residential address, date of birth, social security number, driver's license number, and telephone number. For security reasons, any applicant must submit to a background check. It is required that the applicant provide written consent to the inquiry into the applicant's criminal history and driver's record. The background check consent forms may be signed and mailed/faxed to the administrator or the background check consent forms may be signed online and submitted electronically to the administrator. Such background check consent forms will be kept on file by the administrator, preferably as part of the member's security file should the applicant be granted membership.

As a part of the background check, the administrator will preferably check if the applicant has a criminal history. If the applicant has any felony convictions on his/her criminal record, the applicant will be denied membership. It will be up to the administrator's discretion as to which kinds of crimes warrant denial of membership. The administrator may also choose to decide that any crime, no matter how minor, will warrant denial of membership.

As another part of the background check, the administrator will preferably check the applicant's driving record. If the applicant's driving record is good, meaning little to no moving violations or tickets, then the applicant will be granted membership. If the applicant's driving record is poor, then the applicant will be denied membership. Again, it will be up to the administrator to determine the type and number of infractions that will render an applicant ineligible for membership. Even after membership is granted, periodic background checks of criminal history and driver's records for each member may be completed at the time of membership renewals.

It is also preferable that, during the application process, the applicant read and sign a terms of use agreement (not shown). The terms of use agreement will preferably set forth the rules by which the applicant agrees to abide should the applicant be granted membership. The terms of use agreement may also include a liability waiver, wherein the applicant agrees that the administrator will not be responsible for the applicant's safety, comfort, belongings, etc. It should be clearly understood, however, that substantial benefit may nevertheless be derived without the applicant having to read and sign a terms of use agreement. The terms of use agreement may be signed and mailed/faxed to the administrator or the terms of use agreement may be signed online and submitted electronically to the administrator. The terms of use agreement will be kept on file by the administrator. The administrator will determine whether agreement to the terms of use will be required for membership or whether it will be optional.

Though also not required, it is preferable that the applicant also reads and accepts a privacy policy (not shown) during the application process. The privacy policy will set forth the ways that the administrator will/will not use the applicant's personal information. It should also be clearly understood that substantial benefit may be derived even without the applicant having to read and accept the privacy policy. The applicant's acceptance of the privacy policy may be mailed/faxed to the administrator or the acceptance of the privacy policy may be done online and submitted electronically to the administrator. The applicant's acceptance of the privacy policy will also be kept on file by the administrator. The administrator will also decide whether the acceptance of the privacy policy will be required for membership or whether acceptance of the privacy policy will be optional.

Once a member is granted membership, the member will then preferably pay a fee. This fee would be payable online. Or, more preferably, the administrator will use credit card or bank account information that the applicant would have previously provided on the membership application form. It should be clearly understood that further substantial benefit may be derived from the fee being paid to the administrator through the mail, on the phone, or in person. It should also be clearly understood that further substantial benefit may be derived from the absence of any requirement for a membership fee.

After the person has paid the member fee, the administrator will issue the member a member ID. The member will then create a member account, which includes creating a profile (not shown). The member's profile will preferably include the member's ID, user name, password, system email address, forwarding email address, and credit card/bank account information. It is also preferable that the member be given the opportunity to change his/her user name, password, system email address, forwarding email address, and/or credit card/bank account information at any time online.

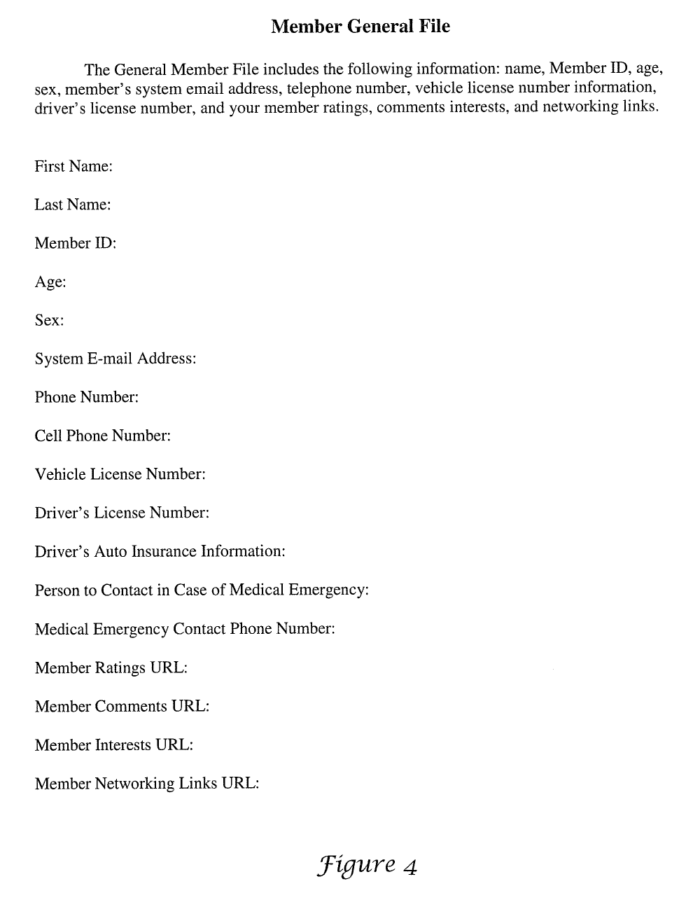

The member may also be asked to submit to the administrator additional information such as, but not limited to, an emergency contact person, medical emergency contact phone number, personal interests, profession, etc. As shown in FIG. 4, some or all of the information that is provided by the member may be used by the administrator to create the member's general file. The member's general file will be available on the system for viewing by other members. The member's general file may include information such as the member's first and last name, member ID, age, sex, system email address, phone number, emergency contact person, medical emergency contact phone number, vehicle license number, member's driver's license number, member driver's auto insurance information, etc. As discussed below, the member's general file may also include the member's ratings, comments, and networking web links.

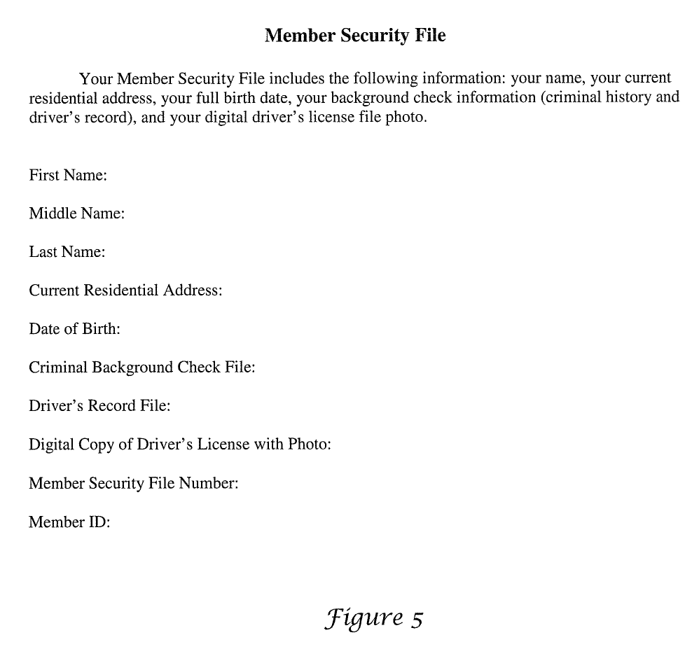

Referring to FIG. 5, a sample member security file is shown. Some of all of the information that is provided by the member may also be used by the administrator to create the member's security file. The member's security file may contain information including, but not limited to, the member's first middle and last name, address, date of birth, criminal background check file, driver's record file, digital copy of driver's license with photo, the security file number, and member ID. Because of the sensitive nature of the information contained in the security file, it is preferable that only an administrator will be allowed access to the members' security files.

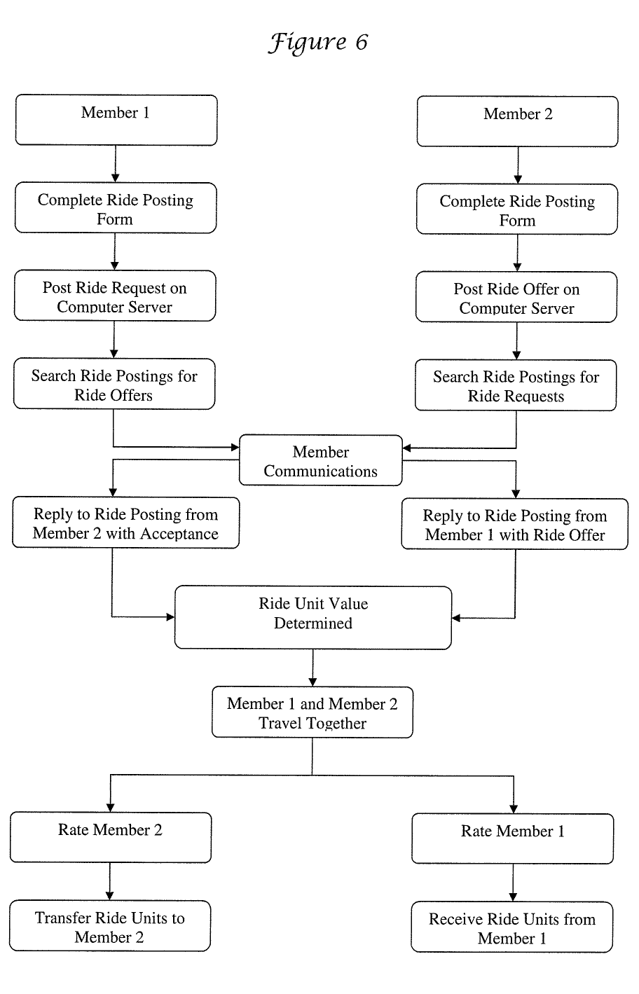

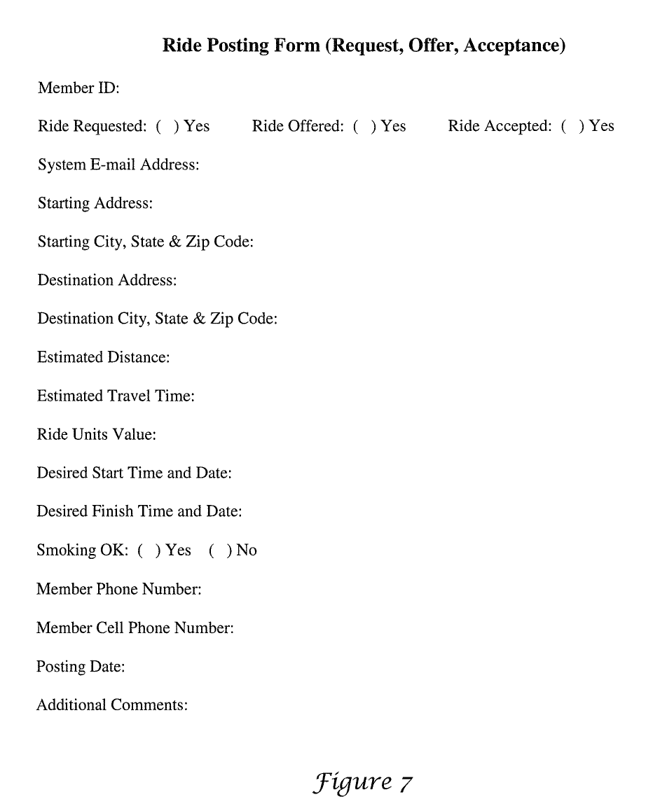

FIG. 6 shows the steps involved in planning and sharing of a ride. FIG. 7 shows an example of a ride posting form. The ride posting form could be used for requesting a ride, offering a ride, and/or accepting a ride. As an example, Member 1, who is looking for a ride (i.e. ride requiring program member), would log onto the system with his/her username and password and would complete a ride posting form. On the ride posting form, Member 1 would preferably provide information such as, but not limited to, his member ID, system email address, starting address, destination address, estimated distance, estimated travel time, desired start/finish time and date, phone number, and whether Member 1 prefers a smoking/nonsmoking ride.

The ride posting form may also indicate how many ride units the ride is worth. This value will preferably be determined by the system where, for example, each ride unit is equivalent to a mile. However, it should be clearly understood that a ride unit may be equivalent to any unit of measurement that the administrator deems appropriate. Alternatively, the ride unit value for the trip may be determined by agreement between the members. Preferably, when a person becomes a member, the member is granted a certain number of ride units of travel. In order to encourage members to offer rides, instead of just requesting rides, the only way for a member to accumulate more ride units for future rides is for that member to provide rides for other members.

Once Member 1 has completed and submitted the ride request posting form online, it will be posted on the computer system and will be available for view online by other members. Member 2, for example, may be looking to replenish some of his/her ride units and would browse online the ride postings for a member or multiple members that are requesting rides. Member 2 (i.e. ride providing program member) would be able to view the ride request form that was posted by Member 1. In viewing Member l's ride posting form, Member 2 will be able to see the details of the ride that Member 1 is requesting. Preferably, Member l's ride posting form will contain a link to Member l's general file. Member 2 will then be able to find out Member l's name, age, sex, vehicle license number, etc. Member 2 will be able to view all of the information that Member 1 had submitted to the administrator for the creation of his/her general file when Member 1 had previously been granted membership.

If Member 2 would like to offer Member 1 a ride, then Member 2 may call or send an email to Member 1 in order to discuss and finalize any ride details. Once the details have been finalized, Member 2 will then log onto the system and will fill out and submit a ride posting form that indicates Member 2's offer of the ride to Member 1. Member 1 may also be required to then submit a ride posting form that indicates Member l's acceptance (agreement response) of Member 2's ride offer. If Member 1 does not want to ride with Member 2, then Member 1 may be required to submit a ride posting form that indicates Member l's denial (denial response) of Member 2's ride offer. By this time, the ride unit value for the ride will need to have been determined, whether by the system or by agreement between Member 1 and Member 2.

After the ride has been completed, Member 1 and Member 2 will need to log onto the system to rate each other and provide any comments that each might have about the quality of their ride experience with the other member. A member's average rating may be calculated in real time, and made available to every other member online. For example, when reviewing the ride postings online, Member 2 would have been able to view the ratings and/or comments that Member 1 received from other members who Member 1 had ridden with on previous occasions. As a further example, Member 2 will also be able to view Member l's networking links to see the other members that Member 1 has ridden with on previous occasions. By viewing these networking links, Member 2 may also view the general files and ratings for those other members that Member 1 had ridden with.

After the ratings have been completed and submitted, the system will transfer the designated number of ride units from Member 1's account to Member 2's account. Preferably, in order to encourage the rating system, the ride units will not be transferred from Member 1 to Member 2 until both of the ratings have been completed and submitted. However, it should be clearly understood that substantial benefit may nevertheless be derived where the ride units may be transferred from Member 1 to Member 2 irrespective of the completion and submission of the member ratings.

As another example, Member 2 may have been the one that submitted a ride posting form indicating that he/she was offering a ride. Member 1, looking for a ride, may have been the one browsing the ride postings online and reviewed Member 2's general file, ratings, and networking information. Member 1 would then contact Member 2 and the two members would discuss finalize the details. Member 1 and Member 2 would then share the ride, rate each other, and transfer ride units as described above. Alternatively, it is also possible that both Member 1 and Member 2 had each posted ride posting forms (request, offer) and that both members browsed the ride posting forms. It should also be understood that substantial benefit may be derived from the system identifying close or proximal ride postings (requests, offers) and creating a list of potential matches for start location, destination, dates, times, etc.

Oftentimes, unforeseen issues may arise that may prevent a person that has committed to offering a ride from showing up. A 24-hour call center may be set up to deal with these situations. For example, if Member 2 does not show up to drive Member 1 as agreed upon, Member 1 may call the 24-hour call center to request a taxi to take Member 1 to his/her destination. Member 1 should then retain his/her receipt for money paid to the taxi driver. Member 1 may then submit the receipt to the administrator so that the administrator may charge the cost of the taxi to the account of Member 2. It should be clearly understood, however, that further substantial benefit may be derived from Member 1 calling a taxi company directly (instead of having to call a 24-hour call center).

While the invention has been particularly shown and described with reference to preferred embodiments thereof, it will be understood by those skilled in the art that the foregoing and other changes in form and details may be made therein without departing from the spirit and scope of the invention.

What is claimed is:

1. A method in a computer system for a ride sharing program comprising the steps of:
determining an amount of ride units for a ride;
agreeing between at least two program members to share the ride; and
transferring the amount of ride units from an account of one program member to an account of a another program member upon completion of the ride.

2. The method of claim 1 further comprising the steps of:
accessing the computer system by a ride providing program member;
posting an offer for a ride to a predetermined destination by the ride providing program member;
entering and storing the offer for the ride in a database; and
receiving notification by the ride providing program member of an acceptance of the offer for the ride by at least one ride requiring program member.

3. The method of claim 2 further comprising the steps of:
accessing the computer system by the at least one ride requiring program member;
selecting the offer for the ride to the predetermined destination by the at least one ride requiring program member from a list of a plurality of posted offers for rides stored in the database; and
posting an acceptance of the offer for the ride to the predetermined destination by the at least one ride requiring program member.

4. The method of claim 3 further comprising the step of the ride providing program member posting one of an agreement response and a rejection response to the acceptance of the offer for the ride that was posted by the at least one ride requiring program member.

5. The method of claim 1 further comprising the steps of:
accessing the computer system by a ride requiring program member;
posting a request for a ride to a predetermined destination by the ride requiring program member;
entering and storing the request for the ride in a database; and
receiving notification by the ride requiring program member of an offer for the ride by at least one ride providing program member.

6. The method of claim 5 further comprising the steps of:
accessing the computer system by the at least one ride providing program member;
selecting the request for the ride to the predetermined destination by the at least one ride providing program member from a list of a plurality of posted requests for rides stored in the database; and
posting an offer for the ride to the predetermined destination by the at least one ride providing program member.

7. The method of claim 6 further comprising the step of the ride requiring program member posting one of an agreement response and a rejection response to the offer for the ride that was posted by the at least one ride providing program member.

8. The method of claim 1 wherein program membership is contingent upon a background check performed by a program administrator.

9. The method of claim 1 further comprising the step of granting a program member a predetermined amount of ride units upon initiation of membership.

10. The method of claim 9 further comprising the step of purchasing additional ride units by a program member from a system administrator.

11. The method of claim 9 further comprising the step of earning additional ride units by a program member providing a ride to at least one other program member to a predetermined destination.

12. The method of claim 1 further comprising the steps of:
obtaining alternative transportation by a ride requiring program member when a ride providing program member does not appear for the ride;
submitting proof of cost for the alternative transportation by the ride requiring program member to a program administrator; and
billing the ride providing program member for the cost of the alternative transportation incurred by the ride requiring program member.

13. The method of claim 1 further comprising the step of rating a program member by another program member upon completion of the ride.

14. A method in a computer system for a ride sharing program comprising:
logging on to the computer system by a ride providing program member;
posting an offer for a ride to a predetermined destination by the ride providing program member;
determining an amount of ride units for the ride to the predetermined destination;
storing the offer for the ride in a database;
logging on to the computer system by a at least one ride requiring program member;
browsing a list of posted ride offers stored in the database by the at least one ride requiring program member;
posting an acceptance for the offer for the ride to the predetermined destination by the at least one ride requiring program member;
notifying the ride providing program member of the posting of the acceptance for the ride to the predetermined destination;
posting by the ride providing program member of one of an agreement response and a rejection response to the acceptance for the offer for the ride that was posted by the at least one ride requiring program member;
agreeing between the ride providing program member and the at least one ride requiring program member to share the ride; and
transferring the amount of ride units from an account of the at least one ride requiring program member to an account of the ride providing program member upon completion of the ride.

15. The method of claim 14 further comprising the steps of:
logging on to the computer system by a ride requiring program member;
posting a request for a ride to a predetermined destination by the ride requiring program member;
determining an amount of ride units for the ride to the predetermined destination;
storing the request for the ride in a database;
logging on to the computer system by at least one ride providing program member;
browsing a list of posted ride requests stored in the database by the at least one ride providing program member;
posting an offer for the ride to the predetermined destination by the at least one ride providing program member;
notifying the ride requiring program member of the posting of the offer for the ride to the predetermined destination;
posting by the ride requiring program member of one of an agreement response and a rejection response to the offer for the ride that was posted by the at least one ride providing program member;
agreeing between the ride requiring program member and one ride providing program member to share the ride;
transferring the amount of ride units from an account of the ride requiring program member to an account of the ride providing program member upon completion of the ride.

16. The method of claim 14 further comprising the steps of:
obtaining alternative transportation by the ride requiring program member when the ride providing program member does not appear for the ride;
submitting by the ride requiring program member proof of cost for the alternative transportation to a program administrator; and
billing the ride providing program member for the cost of the alternative transportation incurred by the ride requiring program member.

17. The method of claim 14 further comprising the step of the ride requiring program member and the ride providing program member rating each other upon completion of the ride.

18. The method of claim 14 further comprising the steps of:
granting a program member a predetermined amount of ride units upon initiation of membership; and
receiving additional ride units by one of purchasing the additional ride units by the program member from a system administrator and by the program member providing a ride to another program member.

19. A computer readable medium containing instructions for controlling a computer system for facilitating a ride sharing program comprising:
determining an amount of ride units for a ride by the computer system;
agreeing between at least two program members to share the ride; and
transferring the amount of ride units from an account of a ride requiring program member to an account of a ride providing program member upon completion of the ride.

20. The computer readable medium of claim 19 further comprising a program member interface accessible by a program member from a location remote from the computer system, the program member interface for facilitation of posting at least one of an offer for a ride to a predetermined destination, a request for a ride to a predetermined destination, an acceptance of an offer for a ride to a predetermined destination, and an offer in response to a request for a ride to the predetermined destination.
